(19) United States
(12) Patent Application Publication
(10) Pub. No.: US 2004/0240364 A1
(43) Pub. Date: Dec. 2, 2004

(54) Optical recording medium and apparatus for recording/reproducing data on or from the same

(76) Inventor: Jung Bae Park, Anyang-si (KR)

Correspondence Address: BIRCH STEWART KOLASCH & BIRCH, PO BOX 747, FALLS CHURCH, VA, 22040-0747, US

(21) Appl. No.: 10/853,291

(22) Filed: May 26, 2004

(30) Foreign Application Priority Data
May 26, 2003 (KR) 10-2003-0033262

(51) Int. Cl. G11B 5/09; G11B 7/24

(52) U.S. Cl. 369/59.21; 369/275.4

(57) ABSTRACT

An optical recording medium such as an optical disc and an apparatus for recording/reproducing data on or from the medium are provided. Data of various information such as copy protection information, disc type identification, main disc information or the like is recorded on the side (or peripheral edge) of an optical disc such as a CD, a DVD or a BD. When the optical disc is loaded, data recorded on the side of the optical disc is read and a playback operation is performed according to the read data. Various additional information can be effectively recorded on the side of the optical disc without reducing the recording capacity. When an optical disc is loaded, it is possible to determine the disc type of the optical disc more rapidly. Main information such as copy protection information can be effectively prevented from being easily copied.

### 1. TECHNICAL FIELD

The present invention relates to an optical recording medium and an apparatus for recording/reproducing data on or from the same, and more particularly to an optical disc such as a CD, DVD or a BD (Blue-ray Disc) on the side (or peripheral edge) of which data is recorded.

### 2. BACKGROUND ART

Generally, an optical disc such as a CD or a DVD has been widely spread and commercialized as a medium on which digital data can be stored. An optical disc apparatus capable of reproducing and recording data on the optical disc has also been commercialized. Recently, a new high-density optical disc (for example, a BD) capable of reproducing or recording a large amount of audio data of a high sound quality and a large amount of video data of a high image quality is under development.

As shown in FIG. 1, the optical disc includes a clamping area assigned to an innermost periphery of the disc, and further includes a lead-in area, a data area and a lead-out area assigned in order from the inner to outer periphery of the disc.

As shown in FIG. 2, an optical disc playback apparatus for reproducing data recorded on the optical disc 10 includes, for example, an optical pickup, which includes an objective lens 20, an actuator 21, a beam splitter 22, a laser diode 23 and a photo detector 24, a driver 25 for driving the optical pickup and a spindle motor, a microcomputer 26, an RF module 27, and a digital signal processor 28. As shown in FIG. 2, the optical disc 10 loaded in the optical disc playback apparatus is, for example, a 1.2 mm thick DVD with a recording layer formed at the center thereof in the thickness direction.

When the optical disc 10 is loaded in the optical disc playback apparatus, the microcomputer 26 of the apparatus controls the operation of the optical pickup driver 25 to adjust drive voltage applied to the actuator 21 provided in the optical pickup, so as to move the objective lens 20 to a preset initial position thereof.

While gradually raising the objective lens 20 from the initial position toward the optical disc 10, the optical disc playback apparatus detects a just focus point of the recording layer of the optical disc 10, with reference to a focus error signal detected by the photo detector 24 provided in the optical pickup or an RF signal output from the RF module 27, as shown in FIG. 2.

The optical disc playback apparatus reads navigation information (for example, Copy Protection Information (CPI), disc type identification (Disc_Type) (DT), and disc information (DI)) recorded in the lead-in area of the optical disc 10, and performs a series of operations for reproducing data on the disc 10 according to the read navigation information.

However, since the navigation information is recorded on the optical disc in the lead-in area, the data area or the lead-out area, which are separately assigned to the plane of the disc as described above, the limited data recording capacity of the optical disc is reduced, for example if various navigation information is additionally recorded on the optical disc. However, an effective method for overcoming this problem has not been provided.

There is also a need to provide an effective method for detecting the disc type of an optical disc sufficiently rapidly when the disc is loaded or for preventing the main information of an optical disc such as the copy protection information from being easily copied by a general playback operation.

### 3. DISCLOSURE OF INVENTION

Therefore, the present invention has been made in view of the above problems, and it is an object of the present invention to provide an optical disc on the side (or peripheral edge) of which various data is additionally recorded.

It is another object of the present invention to provide an apparatus for playing an optical disc on the side of which data is recorded.

In accordance with one aspect of the present invention, the above and other objects can be accomplished by the provision of an optical recording medium having a predetermined thickness, said medium including: a side data area formed on a side thereof, data being recorded on the side data area.

In accordance with another aspect of the present invention, there is provided an apparatus for recording/reproducing data on or from an optical recording medium, the apparatus comprising: an optical pickup for recording or reading data on or from an optical recording medium; a signal processor for processing data to be recorded on the optical recording medium or processing data read from the optical recording medium by the pickup; a driver for driving the optical pickup and a spindle motor; a detector for detecting data recorded on a side of an optical recording medium; and a controller for controlling the driver, the optical pickup or the signal processor to record or read data on or from the optical recording medium based on the data detected from the detector.

### 4. BRIEF DESCRIPTION OF DRAWINGS

The accompanying drawings, which are included to provide a further understanding of the invention, illustrate the preferred embodiments of the invention, and together with the description, serve to explain the principles of the present invention.

FIG. 1 is a diagram showing the structure of a general optical disc;

FIG. 2 is a block diagram showing the configuration of a general optical disc playback apparatus;

FIG. 3 is the structure of an optical disc according to the present invention; and

FIG. 4 is a block diagram showing the configuration of an optical disc apparatus to which the present invention is applied.

Features, elements, and aspects of the invention that are referenced by the same numerals in different figures represent the same, equivalent, or similar features, elements, or aspects in accordance with one or more embodiments.

### 5. MODES FOR CARRYING OUT THE INVENTION

Preferred embodiments of an optical recording medium and an apparatus for recoding/reproducing data on the same according to the present invention will now be described in detail with reference to the accompanying drawings.

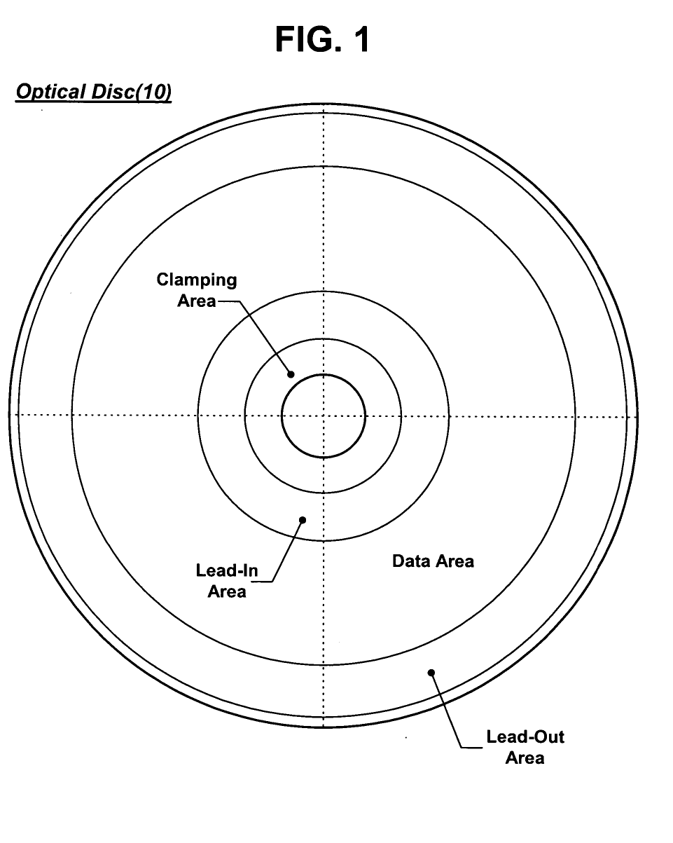

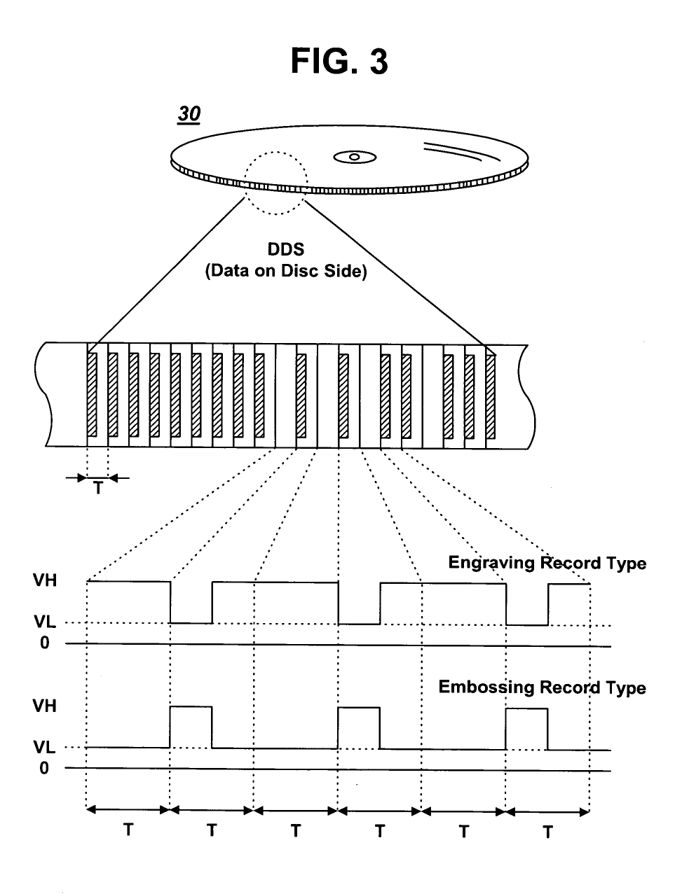

First, an optical recording medium (for example an optical disc such as a CD, a DVD or a BD) according to the present invention has a lead-in area, a data area and a lead-out area which are separately assigned to the plane of the disc, as described above with reference to FIG. 1. As shown in FIG. 3, various data such as Copy Protection Information (CPI), disc type identification (Disc_Type) or Disc Information (DI), for example Data on Disc Side (DDS) data, is recorded on the side of the optical disc.

During the optical disc manufacturing procedure, the DDS data can be recorded on the side of a disc in a punching process after disc cutting, in a laser-based disc cutting process or in a barcode printing process. The DDS data may be recorded on the side of the disc in an embossed or engraved form (for example, in the form of embossed or engraved barcode stripes as shown in FIG. 3). The recording density of the DDS data may be determined by the angular speed of the optical disc or the decoding speed of the data.

FIG. 3 shows an optical disc on which barcode type DDS data is recorded in the form of embossed or engraved barcode stripes at intervals of a predetermined period. As shown in FIG. 3, when barcode type DDS data recorded in the form of engraved barcode stripes is read, an analog signal of a low level voltage VL is detected at each of the barcode stripes. On the other hand, when barcode type DDS data recorded in the form of embossed barcode stripes is read, an analog signal of a high level voltage VH is detected at each of the barcode stripes.

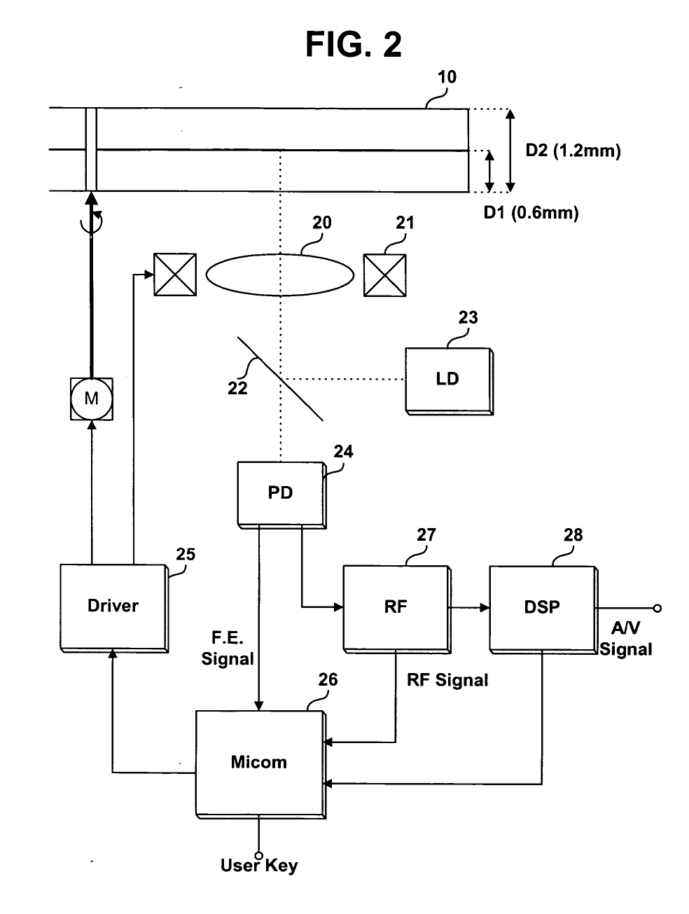

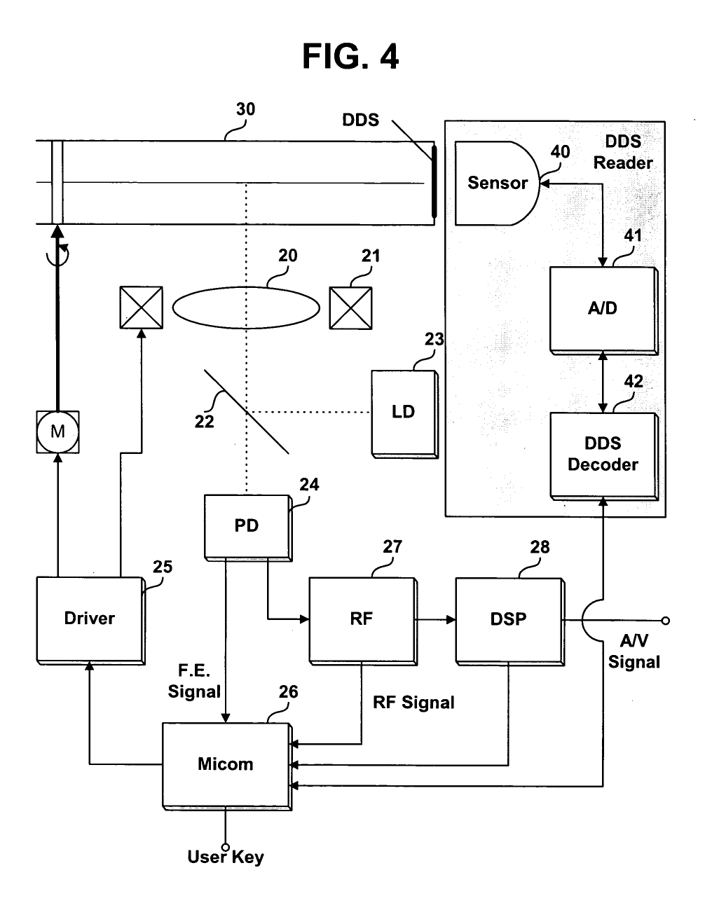

As described above with reference to FIG. 2, an optical disc apparatus, to which a disc recording/reproducing apparatus according to the present invention is applied, includes an optical pickup, which includes an objective lens 20, an actuator 21, a beam splitter 22, a laser diode 23 and a photo detector 24, a driver 25 for driving the optical pickup and a spindle motor, a microcomputer 26, an RF module 27, and a digital signal processor 28. As shown in FIG. 4, the optical disc apparatus further includes a DDS reader that is composed of a sensor 40, an A/D converter 41 and a DDS decoder 42. The sensor 40 reads DDS data recorded on the side of an optical disc 30 loaded in the apparatus and outputs a read analog signal. The A/D converter 41 converts the read analog signal to a digital signal. The DDS decoder 42 decodes the A/D converted digital signal output from the A/D converter into original data.

When the optical disc 30 is loaded in the apparatus, the optical disc 30 rotates at a predetermined rotational speed, and the sensor 40 reads data (for example, barcode type DDS data recorded in the form of barcode stripes) recorded on the side of the optical disc 30 based on the reflectance difference. When barcode type DDS data recorded in the form of engraved barcode stripes is read, each of the barcode stripes causes an output analog signal to shift to a low level voltage VL. On the other hand, when barcode type DDS data recorded in the form of embossed barcode stripes is read, each of the barcode stripes causes an output analog signal to shift to a high level voltage VH.

The A/D converter 41 A/D converts the analog signal shifting to the high voltage or to the low voltage, produced by the embossed or engraved barcode stripes, to a digital signal after sampling the analog signal at a predetermined sampling frequency. The DDS decoder 42 decodes the A/D converted digital signal to detect copy protection information, disc type identification, disc information or the like, and provides the detected information to the microcomputer 26.

The microcomputer 26 refers to the detected information to perform a series of playback control operations more rapidly and accurately. For example, if the disc type of a loaded optical disc is detected by the DDS data, the detection allows the microcomputer 26 to perform a more rapid servo operation suitable for the disc type of the optical disc. In addition, if the copy protection information of a loaded optical disc is detected by the DDS data, the microcomputer 26 can decrypt encrypted data recorded on the optical disc into decrypted data, based on the detected copy protection information.

As described above, various additional information can be recorded on the side of an optical disc effectively without reducing the limited recording capacity of the optical disc. In addition, when an optical disc is loaded, the disc type of the optical disc can be determined more rapidly, and main information of the optical disc such as copy protection information can be prevented from being easily read by a general playback operation.

For reference, a BCA area assigned to a general blue-ray disc is radially spaced apart from the center of the disc by a distance of 21.3˜22.0 mm. The BCA area is 0.7 mm wide, whereas the side of an optical disc to which the present invention is applied is 1.2 mm thick. Therefore, compared to data that can be recorded on the BCA area, a large amount of information can be securely recorded in the side of the optical disc.

Even though data recorded on the plane of an optical disc to which the present invention is applied is illegally copied, important information (for example, a decryption key used for data decryption) recorded on the side of the optical disc cannot be copied. Thus, the optical disc according to the present invention can be used effectively for copy protection since data on the optical disc cannot be reproduced normally even if the optical disc is copied without permission.

Since a similar device to the conventional barcode reader can be used for the sensor 40 of the DDS reader and the DDS reader can be embodied as one chip, it is possible to minimize modifications required to apply the present invention to the conventional optical disc playback apparatus.

As apparent from the above description, an optical recording medium and an apparatus for recording/reproducing data on the same according to the present invention have the following advantages. First, the side (or peripheral edge) of an optical disc is also used, which allows the disc to record a larger amount of data, compared to the conventional BCA-based disc.

In addition, when an optical disc is loaded, the disc type of the optical disc can be determined more rapidly.

Further, since important data is recorded on the side of an optical disc, direct disc copy of the disc is not possible.

Furthermore, data recorded on the side of an optical disc can be stably read even by using a cheap solution having similar specifications to commercial barcode readers in the prior art.

Moreover, since a device for reading data recorded on the side of an optical disc can be embodied as one chip, it is possible to minimize modifications to the existing optical disc playback apparatus.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An optical recording medium having a predetermined thickness, said medium including a side data area formed on a side thereof, data being recorded on the side data area.

2. The medium according to claim 1, wherein the data recorded on the side of the optical recording medium includes at least one of copy protection information, disc type identification or main disc information.

3. The medium according to claim 1, wherein recording density of the data recorded on the side of the optical recording medium is determined by rotational speed or decoding speed of the data.

4. The medium according to claim 1, wherein the data is recorded on the side of the optical recording medium in a punching process after cutting of the medium, in a laser-based disc cutting process or in a barcode printing process.

5. The medium according to claim 1, wherein the data is recorded in an embossed or engraved form on the side of the optical recording medium.

6. An apparatus for recording/reproducing data on or from an optical recording medium, the apparatus comprising:
an optical pickup for recording or reading data on or from an optical recording medium;
a signal processor for processing data to be recorded on the optical recording medium or processing data read from the optical recording medium by the pickup;
a driver for driving the optical pickup and a spindle motor;
a detector for detecting data recorded on a side of an optical recording medium; and
a controller for controlling the driver, the optical pickup or the signal processor to record or read data on or from the optical recording medium based on the data detected from the detector.

7. The apparatus according to claim 6, wherein the detector includes:
an analog signal reader for reading data recorded on a side of an optical recording medium and outputting a read analog signal;
an A/D converter for converting the read analog signal to a digital signal; and
a decoder for decoding the converted digital signal into original data.
